(19) United States
(12) Patent Application Publication
(10) Pub. No.: US 2020/0086344 A1
(43) Pub. Date: Mar. 19, 2020

(54) FLOORCOVERINGS STABILIZED WITH WARPS OF FILAMENTS OR YARNS

(71) Applicant: ENGINEERED FLOORS LLC, Dalton, GA (US)

(72) Inventors: John Joseph Matthews REES, Chattanooga, TN (US); Dimitri ZAFIROGLU, Centreville, DE (US)

(21) Appl. No.: 16/576,149

(22) Filed: Sep. 19, 2019

Related U.S. Application Data
(60) Provisional application No. 62/736,022, filed on Sep. 25, 2018.
(60) Provisional application No. 62/733,271, filed on Sep. 19, 2018.

(51) Int. Cl. B05D 7/04; B05D 5/00

(52) U.S. Cl. CPC B05D 7/04; E04F 15/105; B05D 5/00

(57) ABSTRACT

One or more parallel arrays or warps of stabilizing filaments or yarns are introduced into the back of a floorcovering without losing the planar uniformity of the warp, with some of the filaments or yarns optionally reoriented during or after the application to secure multi-directional planar stabilization. Variations include cutting into staple as the warp is introduced, embossing the deposited staple with reorienting patterns, and combining rectilinear and planarly-undulating continuous-filament arrays overlapping to provide multi-directional planar stabilization.

### CROSS REFERENCE TO RELATED APPLICATIONS

The present invention claims priority to U.S. Provisional Patent Application No. 62/733,271 filed Sep. 19, 2018 and 62/736,022 filed Sep. 25, 2018, the entire disclosures of both applications are incorporated herein by reference.

### TECHNICAL FIELD

The present invention is directed to the use of parallel arrays or warps of continuous filaments or yarns containing highly-stable fibers that are directly deposited with planar uniformity onto or into a textile floorcovering or wallcovering or a floorcovering with a solid polymeric surface.

### BACKGROUND

Floorcoverings and wallcoverings, including those with a polymeric face layer or a fibrous face layer are applied to flat surfaces and should remain flat and stable without expanding, contracting, gaping at the seams, or warping out-of-plane. These floorcoverings and wallcoverings, however, are subjected to mechanical stress from traffic and variations in temperature and humidity. In tufted floorcoverings, a layer of “backlaps” under a primary backing assumes a planar configuration after the backlaps are adhesively attached to the backing and control the dimensional expansion and contraction of the floorcovering caused by temperature and humidity variations. To combat the resultant mechanical stresses potentially causing gaps at the seams or warping on the floor, stabilizing layers have been attached to the back of polymeric or fibrous floorcoverings and wallcoverings. These stabilizing layers usually employ fibers that are relatively unaffected by temperature or humidity variations, e.g., fiberglass fibers.

Stabilizing fibers have been introduced into the backsides of fibrous floorcoverings such as tufted structures or woven, knit or stitched structures, or nonfibrous polymeric structures such as vinyl or polyester faced tiles. The stabilizing fibers have been introduced in the form of woven or cross-bonded fabrics prepared with yarns or continuous filaments and in the form of nonwoven webs or fabrics prepared with continuous filaments or cut staple fibers. To achieve planarly-uniform multi-directional stabilization in the resulting floorcovering or wallcovering, these forms of the stabilizing fibers require processes such as weaving, cross-bonding, nonwoven web formation and other special processes for uniform introduction to the back of the floorcovering or wallcovering. Highly-stable stiff and brittle fibers such as glass cannot be crimped or bulked, cannot be processed with standard staple processing equipment, create multiple processing difficulties, and consequently limit the economics, the directional balance of the product, and the flexibility and effectiveness of conventional applications.

### SUMMARY

Exemplary embodiments are directed to the use of parallel arrays of dimensionally-stable yarns or filaments or segments of yarns or filaments, i.e., stabilizing fibers, that are deposited and adhesively affixed onto the back surface of a surface covering to stabilize the surface covering. Parallel arrays of yarns or filaments are commonly referred to as “warps”. The surface covering can be a floorcovering or a wallcovering. The warps are arranged in a pre-determined pattern before application to the back surface, and that pre-determined pattern is maintained on the back surface following deposition of the warps. In one embodiment, the filaments or yarns in the warp are equidistant. In one embodiment, the distance between filaments or yarns is variable with a pattern intended to optimize the stabilization. In one embodiment, all filaments or yarns in the warp are identical. In one embodiment, the filaments or yarns vary in accordance with an optimizing pattern. The warps may also contain yarns or filaments with a melting temperature lower than that of the stabilizing filaments or yarns. The warps containing these yarns or filaments can be used as the main adhesive or as an auxiliary adhesive in the fibrous-faced surface covering.

The warps are in all cases deployed in the direction of the filaments or yarns i.e. the “MD” or “machine direction”. When the warps are deposited under tension only the machine-directional or MD properties of the surface covering are stabilized. To add stabilization in the “XD” or “cross-machine direction” the filaments or yarns are deployed at a higher speed, i.e., with “overfeed”, to cause undulation and overlapping as the filaments or yarns are deposited. Optionally, undulation of the filaments or yarns is augmented or controlled by mechanical means. Suitable mechanical means include, but are not limited to, using oscillating guides and using oscillating air nozzles. In one embodiment, the deposited overfed filaments are also rearranged after deposition, either before or after the addition of adhesive, into two-directional patterns. Rearrangement after deposition can be accomplished by impressing using mechanical means, for example, with patterned tools, intermittent air jets, or diagonal brushing.

In one embodiment, the filaments or yarns of the warp are cut, broken or chopped into individual staple fibers. In one embodiment the chopped individual staple fibers are released and deposited onto or into an adhesive applicator depositing adhesive onto the back of the surface covering. In one embodiment the chopped individual staple fibers are deposited directly onto the back surface, either before or after the application of adhesive, while maintaining the desired pattern and the local weight distribution from the filaments or yarns of the warp. In one embodiment, the chopped stabilizing or staple fibers are released from a distance, e.g., a minimum distance, above the surface or interface onto which they are deposited. Therefore, the pattern of the warp and the local area weight distribution and uniformity are maintained and transferred to the stabilizing layer formed on the fibrous-faced surface covering.

As some of the broken or cut staple fibers can re-orient away from the machine or delivery direction as they are released into an applicator or into the space above the back of the surface covering, some degree of cross-directional planar stabilization is automatically provided by the deposited staple fibers. This reorientation can be amplified by overfeeding the warp at a faster rate than the machine-directional movement of the surface covering. Additional amplification can be provided by introducing additional reorientation of the staple fibers after deposition using the same mechanical means available for deposited uncut overfed warps. This reorientation can be provided randomly or in accordance with a desired order or pattern to provide additional multi-directional stability. Suitable reorientation methods include, but are not limited to, pressing the deposited layer with a pattern of projections, applying intermittent localized air jets and diagonal brushing.

Exemplary embodiments are directed to methods for stabilizing a surface covering. A plurality of stabilizing fibers is arranged in a pre-determined pattern having a uniformity of weight per unit of planar area of stabilizing fibers. In one embodiment, the predetermined pattern is a rectilinear warp of continuous yarns or continuous filaments. The plurality of stabilizing fibers is deposited and adhesively attached onto a back surface of the surface covering while maintaining the uniformity of weight per unit of planar area of stabilizing fibers. The stabilizing fibers have a fiber coefficient of thermal expansion and a fiber coefficient of hygroscopic expansion, and the surface covering has a covering coefficient of thermal expansion and a covering coefficient of hygroscopic expansion. In one embodiment, the fiber coefficient of thermal expansion is smaller than the covering coefficient of thermal expansion, and the fiber coefficient of hygroscopic expansion is less than the covering coefficient of hygroscopic expansion. In one embodiment, the fiber coefficient of thermal expansion is smaller than one half of the covering coefficient of thermal expansion of the surface covering.

In one embodiment, the continuous yarns or continuous filaments are cut into a plurality of staple fibers, and the staple fibers are deposited onto the back surface of the surface covering while maintaining the uniformity of weight per unit of planar area of stabilizing fibers. In one embodiment, the staple fibers are deposited into an adhesive puddle containing adhesive, and depositing and adhesively attaching the stabilizing fibers includes applying the adhesive containing the staple fibers from the adhesive puddle to the back surface of the surface covering. In one embodiment, the stabilizing fibers are deposited on a roller in communication with an adhesive puddle comprising adhesive, and depositing and adhesively attaching the stabilizing fibers includes using the roller to transfer the staple fibers into the adhesive and applying the adhesive containing the staple fibers to the back surface of the surface covering.

In one embodiment, the rectilinear warp of continuous yarns or continuous filaments includes additional low-melting adhesive fibers, and depositing and adhesively attaching the plurality of stabilizing fibers involves applying heat to the back surface after deposition of the stabilizing fibers on the back of the surface covering to activate the additional low-melting adhesive. In one embodiment, at least a portion of the stabilizing fibers are reoriented while depositing and adhesively attaching the stabilizing fibers on the back surface. In one embodiment, depositing and adhesively attaching the plurality of stabilizing fibers includes applying adhesive to the back surface using a puddle-coater, a spray-coater, a roll-coater or a hot-melt extruder. In one embodiment, depositing and adhesively attaching the plurality of stabilizing fibers further includes depositing the plurality of stabilizing fibers simultaneously with applying the adhesive. In one embodiment, depositing and adhesively attaching the plurality of stabilizing fibers includes applying adhesive to the back surface after depositing the plurality of stabilizing fibers.

In one embodiment, a planar orientation of the stabilizing fibers deposited on the back surface is modified using a stream of air applied to the back surface or diagonal brushing across the back surface. In one embodiment, the rectilinear warp of continuous yarns or continuous filaments is a uniformly spaced parallel pattern of continuous yarns or continuous filaments. In one embodiment, at least one of a material composition of the stabilizing fibers, a denier and a spacing between stabilizing fibers in the predetermined pattern is varied. In one embodiment, the surface covering is a tufted fibrous surface covering, and the back surface contains back-laps of the tufted fibrous surface covering. In one embodiment, the surface covering is a woven fibrous surface covering, a knit fibrous surface covering or a nonwoven fibrous surface covering.

In one embodiment, an additional layer is placed on the back surface and adhesive is applied to the additional layer. The plurality of stabilizing fibers is deposited over the adhesive on the additional layer. In one embodiment, the additional layer is a thermoplastic adhesive layer, a cushioning layer, a fluid blocking layer, or a protective layer. In one embodiment, the surface covering containing the pre-determined pattern of adhesively attached stabilizing fibers is embossed using an embossing tool having a plurality of projections to displace at least of portion of the stabilizing fibers and modify a planar orientation of the displaced stabilizing fibers.

Exemplary embodiments are also directed to a method for stabilizing a surface covering by arranging a first plurality of stabilizing fibers in a first pre-determined pattern containing a first warp of continuous yarns or continuous filaments with a first uniformity of weight per unit of planar area of stabilizing fibers, depositing the first plurality of stabilizing fibers onto a back surface of the surface covering while maintaining the first uniformity of weight per unit of planar area of stabilizing fibers, arranging a second plurality of stabilizing fibers in a second pre-determined pattern having a second warp of continuous yarns or continuous filaments with a second uniformity of weight per unit of planar area of stabilizing fibers, and depositing the second plurality of stabilizing fibers onto the back surface of the fibrous-based surface covering over the first plurality of stabilizing fibers while maintaining the second uniformity of weight per unit of planar area of stabilizing fibers.

In one embodiment, adhesive is applied to the back surface. In one embodiment, depositing the first plurality of stabilizing fibers includes releasing the first warp onto the back surface at a first speed matching a speed of propagation of the surface covering to deposit the first warp as a parallel rectilinear array and depositing the second plurality of stabilizing fibers includes overfeeding the second warp onto the back surface at a second speed exceeding the speed of propagation of the surface covering to deposit the second warp as an undulating pattern. In one embodiment, depositing the first plurality of stabilizing fibers includes overfeeding the first warp onto the back surface at a first speed exceeding a speed of propagation of the surface covering to deposit the first warp as an undulating pattern, and depositing the second plurality of stabilizing fibers includes overfeeding the second warp onto the back surface at a second speed exceeding the speed of propagation of the surface covering to deposit the second warp as an undulating pattern. In one embodiment, the first pre-determined pattern and the second pre-determined pattern are distinct patterns. In one embodiment, at least one of the first warp or the second warp is cut into staple fibers before depositing onto the back surface.

### BRIEF DESCRIPTION OF THE DRAWINGS

The accompanying drawings, which are incorporated in and constitute a part of the specification, illustrate a plurality of embodiments and, together with the following descriptions, explain these embodiments.

FIG. 1 is a schematic representation illustrating a warp of reinforcing yarns chopped at close proximity over and into an adhesive pool of an adhesive applicator for depositing fiber-loaded adhesive onto the back surface of a surface covering;

FIG. 2 is a schematic representation illustrating a warp of yarns chopped at close proximity and deposited onto a roller that is part of an applicator depositing adhesive onto the back surface of a surface covering;

FIG. 3 is a schematic representation as in FIG. 2 with an applicator belt replacing the applicator roller;

FIG. 4 is a schematic representation as in FIG. 2 wherein the applicator roller is perforated, and compressed air is locally applied from within the roller under the line of contact with the pool of adhesive to propel the stabilizing fibers into the puddle and orient the stabilizing fibers in multiple directions;

FIG. 5 is a schematic representation as in FIG. 4 wherein the stabilizing fibers are released onto a foraminous applicator belt and propelled with air into the adhesive puddle;

FIG. 6 is a schematic representation illustrating a warp of stabilizing fibers chopped at close proximity onto the back surface of a tufted structure before or after application of adhesive;

FIG. 7 is a schematic representation illustrating a warp of stabilizing fibers chopped at close proximity and deposited over the back surface of a tufted structure covered with an adhesive precoat delivered by a variety of applicators;

FIG. 8 is a schematic representation illustrating two warps applied to the back surface of a tufted structure at two different speeds after an adhesive precoat is applied;

FIG. 9 is a schematic representation illustrating two warps chopped and applied to the back surface of a tufted surface from two different elevations with the option of two different speeds after the application of adhesive;

FIG. 10 is a schematic representation illustrating the stabilizing fiber patterns resulting from the deposition arrangement of FIG. 8;

FIG. 11 is a schematic representation illustrating the pattern of continuous yarns or filaments and cut staple fibers resulting from the deposited warps of FIG. 9; and

FIG. 12 is a schematic representation illustrating methods to re-orient staple fibers or warps deposited onto the back surface of a surface covering.

### DETAILED DESCRIPTION

The following description of the embodiments refers to the accompanying figures. The same reference numbers in different figures identify the same or similar elements. Reference throughout the whole specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, particular features, structures or characteristics may be combined in any suitable manner in one or more embodiments.

Exemplary embodiments are directed to a method for stabilizing a surface covering using arrangements of stabilizing fibers applied to the back surface of the surface covering and to the stabilized surface coverings containing the stabilizing fibers. Suitable surface coverings include fibrous-faced surface coverings such as a woven fibrous-faced surface covering, a knit fibrous-faced surface covering, a nonwoven fibrous-faced surface covering and a tufted fibrous-faced surface covering. When the fibrous-faced surface covering is a woven fibrous-faced surface covering, a knit fibrous-faced surface covering or a nonwoven fibrous-faced surface covering, the back surface is a back face. When the fibrous-faced surface covering is a tufted fibrous-faced surface covering, the back surface is the back-laps formed by the tufted yarns. Suitable surface coverings also include surface coverings having solid face layers, i.e., a non-fibrous face surface such as a polymeric face surface. In one embodiment, the surface covering is a vinyl faced tile or a polyester faced tile.

As used herein, stabilizing fibers include continuous yarns or filaments and segments cut from the continuous yarns or filaments, e.g. staple fibers. Yarns includes any type of yarn formed from filaments or fibers, for example, single continuous filaments or fibers, bundles of continuous filaments or fibers and bundles of staple fibers. The stabilizing fibers, and therefore, the yarns, filaments or segments of yarns or filaments, have a fiber coefficient of thermal expansion and a fiber coefficient of hygroscopic expansion. The surface covering has a covering coefficient of thermal expansion and a covering coefficient of hygroscopic expansion. The components or materials of the stabilizing fibers are selected such that the fiber coefficient of thermal expansion is significantly lower than the covering coefficient of thermal expansion and the fiber coefficient of hygroscopic expansion is at least as low as the covering coefficient of hygroscopic expansion. In one embodiment, the fiber coefficient of thermal expansion is less than one half the covering coefficient of thermal expansion. In one embodiment, the fiber coefficient of hygroscopic expansion is less than the covering coefficient of hygroscopic expansion.

The stabilizing fibers are applied across the back surface of the surface covering in accordance with a pre-determined pattern. In one embodiment, the pre-determined pattern of stabilizing fibers has a desired weight distribution of stabilizing fibers per unit of planar area of the back surface of the surface covering. Suitable weight distributions, for example, for glass fibers, include 50 gm/m² to 300 gm/m². The pre-determined pattern and associated weight distribution of stabilizing fibers define a pattern uniformity or area uniformity of the pre-determined pattern. In one embodiment, the pre-determined pattern is a single, homogenous pattern across the back surface of the surface covering. Suitable homogenous patterns include, but are not limited to, a plurality of parallel rectilinear lines across the back surface, a plurality of parallel curvilinear lines across the back surface, and a random distribution of stabilizing fibers. In one embodiment, the stabilizing fibers are applied as a warp, e.g., a warp of yarns or filaments.

In one embodiment, the pre-determined pattern includes a plurality of distinct and separate overlapping patterns. In one embodiment, at least one of a material composition, a denier, and spacing between adjacent yarns, filaments or segments or yarns or filaments is varied to define or create a pre-determined pattern of stabilizing fibers. In one embodiment, the stabilizing fibers are arranged in a plurality of patterns. In one embodiment, the stabilizing fibers in each pattern are deposited separately on the back face. In one embodiment, the plurality of patterns is deposited on the back surface as overlapping patterns. The overlapping patterns include combinations of homogenous patterns and heterogenous patterns. Suitable overlapping patterns include two or more distinct and separate patterns.

In one embodiment, the overlapping patterns include two patterns, a first pattern containing a plurality of parallel rectilinear lines of stabilizing fibers extending in a direction in which the stabilizing fibers are deposited or released onto the back surface, i.e., the machine direction (MD), and a second pattern comprising a plurality of lines or rows of stabilizing fibers undulating with respect to the direction in which the lines or rows of stabilizing fibers are deposited. The second pattern, having a generally sinusoidal shape, overlaps the first pattern, e.g., is deposited on top of the first pattern. In one embodiment, the stabilizing fibers in a first pattern are deposited as warps extending in a first direction rectilinearly along the back surface, and the stabilizing fibers in a second pattern are deposited over the first pattern with overfeed that produces an undulating pattern of stabilizing fibers overlapping the first pattern. In one embodiment, both the first and second patterns are deposited as undulating patterns of stabilizing fibers.

In one embodiment, the stabilizing fibers are initially a plurality of separate yarns or filaments, e.g., continuous yarns or filaments, arranged in accordance with the pre-determined pattern for deposition on the back surface in accordance with the pre-determined pattern, e.g, a warp. During the process of depositing the stabilizing fibers, i.e., the yarns or filaments, onto the back surface, each yarn or filament in the plurality of separate yarns or filaments is continuously cut or chopped into a plurality of segments while maintaining the overall pre-determined pattern. Therefore, the stabilizing fibers are a plurality or yarn or filament segments arranged in the pre-determined pattern. In one embodiment, each stabilizing fiber, i.e., each yarn or filament segment, has a length of from approximately 5 mm up to approximately 50 mm. The continuous yarns or filaments are cut at a close proximity to the back surface or are cut, deposited onto secondary conveying equipment, conveyed through the secondary conveying equipment, and released from the secondary conveying equipment in close proximity to the back surface so that the pre-determined pattern and pattern uniformity is maintained. Therefore, the stabilizing fibers are deposited onto the back surface as a plurality of segments arranged in the pre-determined pattern, and the desired planar uniformity in the pre-determined pattern is maintained on the back surface.

When the pre-determined pattern includes a plurality of overlapping patterns, i.e., two or more overlapping patterns, the stabilizing fibers can be applied as either continuous yarns or filaments or segments of yarns or filament, e.g., staple fibers, in each one of the plurality of overlapping patterns. In one embodiment, at least one pattern includes continuous yarns or filaments, and at least one pattern includes segments of yarns or filaments. In one embodiment, at least one of the plurality of separate over-lapping patterns includes segments of yarns or filaments. In one embodiment, the stabilizing fibers in at least one of the separate overlapping patterns includes continuous yarns or filaments. In one embodiment, the stabilizing fibers are arranged in a rectilinear pattern or an undulating pattern. Each pattern of stabilizing fibers is deposited onto the back surface of the surface covering while maintaining the planar uniformity of the pattern. In addition to maintaining the planar uniformity of the pattern, the weight distribution of stabilizing fibers per unit of planar area is maintained in each deposited pattern.

In addition to depositing the stabilizing fibers arranged in accordance with a pre-determined pattern that includes one or more layers of patterns, adhesive is applied to the back surface of the surface covering. Suitable adhesives include, but are not limited to, a low melt solid adhesive, a liquid adhesive applied as a solution and a liquid adhesive applied as a suspension. The adhesive is applied before deposition of the stabilizing fibers, after deposition of the stabilizing fibers or simultaneously with the deposition of the stabilizing fibers. In one embodiment, the adhesive containing the stabilizing fibers arranged in accordance with the pre-determined pattern is applied onto the back surface via the adhesive puddle of an adhesive puddle applicator. Suitable adhesive puddle applicators are known and available in the art. In one embodiment, the adhesive is applied on the back surface first, for example, using the adhesive puddle applicator, and the stabilizing fibers arranged in the pre-determined pattern are subsequently applied to the back surface of the surface covering containing the adhesive. Other suitable methods for applying the adhesive include using a spray-coater, using a roll-coater, using a hot-melt extruder, and using a low-melt powder sifter.

In one embodiment, heat or heat and pressure are applied to set the adhesive. In one embodiment, the adhesive is set with the pre-determined pattern of stabilizing fibers attached to the adhesive. Preferably, the adhesive is set with the stabilizing fibers enclosed within the adhesive.

In one embodiment, at least a portion of the stabilizing fibers overlap during deposition while maintaining the pre-determined pattern on the back surface. When an adhesive puddle applicator is used during deposition of the stabilizing fibers, the stabilizing fibers are deposited into the adhesive puddle and are deposited onto the back surface along with the adhesive while maintaining the pre-determined pattern. Therefore, the rate at which the puddle applicator is operated, including the rate of adhesive passing through the adhesive puddle applicator and the rate at which the stabilizing fibers are deposited into the adhesive puddle are coordinated to maintain the pre-determined pattern. Suitable adhesive puddle applicators are known and available in the art. In one embodiment, the stabilizing fibers are deposited onto a roller or a belt in accordance with the pre-determined pattern, and the roller or belt containing the stabilizing fibers enters or contacts the adhesive puddle, contacting the stabilizing fibers with the adhesive puddle.

In addition to depositing the stabilizing fibers on the back surface while maintaining the pre-determined pattern, in one embodiment at least a portion of the stabilizing fibers is intentionally reoriented from the pre-determined pattern while being deposited on the back surface or following deposition onto the back surface. In one embodiment, the planar orientation of the stabilizing fibers across the back surface is modified. Suitable methods for modifying the planar orientation of the stabilizing fibers in the pre-determined pattern include, but are not limited to, pattern embossing, directing a stream of air onto the stabilizing fibers and brushing across the stabilizing fibers at an angle to the direction of propagation of the pattern, e.g., brushing diagonally across the stabilizing fibers.

In one embodiment, the surface covering containing the pre-determined pattern of stabilizing fibers and adhesive on the back surface is embossed. In one embodiment, the surface covering is embossed with an embossing tool containing a plurality of projections. These projections displace the deposited stabilizing fibers either along the planar surface of the back surface, into the back surface or both along the planar surface and into the back surface.

In one embodiment, at least one additional layer is attached to the back surface of the surface covering containing the pre-determined pattern of stabilizing fibers or the pre-determined pattern of stabilizing fibers and adhesive. Suitable additional layers include, but are not limited to, a thermoplastic adhesive layer, soft thermoplastic layers, a cushioning layer, a fluid blocking layer, and a protective layer.

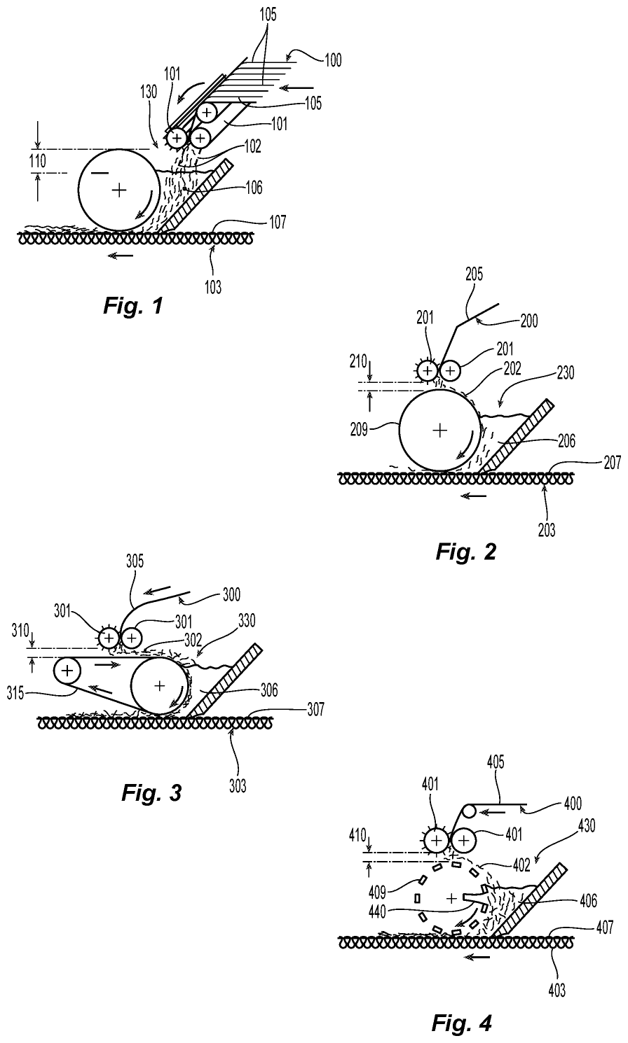

Referring to the figures, examples of methods for stabilizing surface coverings through various arrangements of depositing stabilizing fibers and applying adhesive are illustrated. Referring initially to FIG. 1, a warp 100 containing a plurality of stabilizing fibers initially arranged as a plurality of parallel yarns or filaments 105 is feed fed through and guided between two cutter rolls 101. The cutter rolls chop each yarn or filament into a plurality of segments or staple fibers 102. Therefore, the stabilizing fibers are arranged as staple fibers, and the pre-determined pattern of the initial warp is maintained among the staple fibers. The stabilizing fibers, i.e., the staple fibers, are deposited into the adhesive puddle 106 of an adhesive applicator 130 from a short vertical distance 110 above. In one embodiment, the short vertical distance is less than a length of the cut yarns or filaments. The adhesive applicator transfers the adhesive containing the staple fibers arranged in the initial warp onto the back surface 107 of a tufted fabric 103. The planar uniformity is maintained in the cut staple fibers that are transferred to the back surface. The rate at which the stabilizing fibers are deposited into the adhesive puddle, the rate at which the adhesive is feed through the adhesive puddle and applied to the back surface and the short vertical distance are controlled to maintain the initial warp uniformity, i.e., the pre-determined pattern, in the stabilizing fibers applied to the back surface.

Referring now to FIG. 2, a warp 200 containing a plurality of stabilizing fibers initially arranged as a plurality of parallel yarns or filaments 205 is fed through and guided between two cutter rolls 201 positioned a short vertical distance 210, e.g., a minimum distance, above the front roll 209 of an adhesive puddle applicator 230. The cutter rolls chop each yarn or filament into a plurality of segments or staple fibers 202 that are deposited on the front roll. Therefore, the pre-determined pattern uniformity of a warp is maintained among the staple fibers on the front roll. The front roll delivers the stabilizing fibers to the adhesive puddle 206. The adhesive applicator transfers the adhesive containing the stabilizing fibers onto the back surface 207 of a tufted fabric 203. The rate at which the stabilizing fibers are deposited onto the front roll, the rate at which the front roll is rotated, the rate at which the adhesive is feed through the adhesive puddle, the rate at which the adhesive is applied to the back surface and the short vertical distance are controlled to maintain the initial warp uniformity, i.e., the pre-determined pattern, in the stabilizing fibers applied to the back surface.

Referring to FIG. 3, a warp 300 containing a plurality of stabilizing fibers initially arranged as a plurality of parallel yarns or filaments 305 is fed through and guided between two cutter rolls 301 positioned a short vertical distance 310, e.g., a minimum distance, above a rotating belt 315 of an applicator 330. The cutter rolls chop each yarn or filament into a plurality of segments or staple fibers 302 that are deposited on the belt. The belt delivers the stabilizing fibers, maintained in the warp pattern, to the adhesive puddle 306. The adhesive applicator transfers the adhesive containing the stabilizing fibers onto the back surface 307 of a tufted fabric 303. The rate at which the stabilizing fibers are deposited onto the belt, the rate at which the belt is rotated, the rate at which the adhesive is feed through the adhesive puddle, the rate at which the adhesive is applied to the back surface and the short vertical distance are control to maintain the initial warp alignment, i.e., the pre-determined pattern, in the stabilizing fibers applied to the back surface.

Referring to FIG. 4, a warp 400 containing a plurality of stabilizing fibers initially arranged as a plurality of parallel yarns or filaments 405 is fed through and guided between two cutter rolls 401 positioned a short vertical distance 410, e.g., a minimum distance, above a perforated roll 409 of an applicator 430. The cutter rolls chop each yarn or filament into a plurality of segments or staple fibers 402 that are deposited on the perforated roll. The perforated roll delivers the stabilizing fibers to the adhesive puddle 406 where one or more air jets 440 located within the perforated roll pass air through the perforations to propel the stabilizing fibers into the adhesive puddle. The adhesive applicator transfers the adhesive containing the staple fibers onto the back surface 407 of a tufted fabric 403. The rate at which the stabilizing fibers are deposited onto the perforated roll, the rate at which the perforated roll is rotated, the rate at which the adhesive is feed through the adhesive puddle, the rate at which the adhesive is applied to the back surface and the short vertical distance are controlled to maintain the initial wrap uniformity, i.e., the pre-determined pattern, in the stabilizing fibers applied to the back surface.

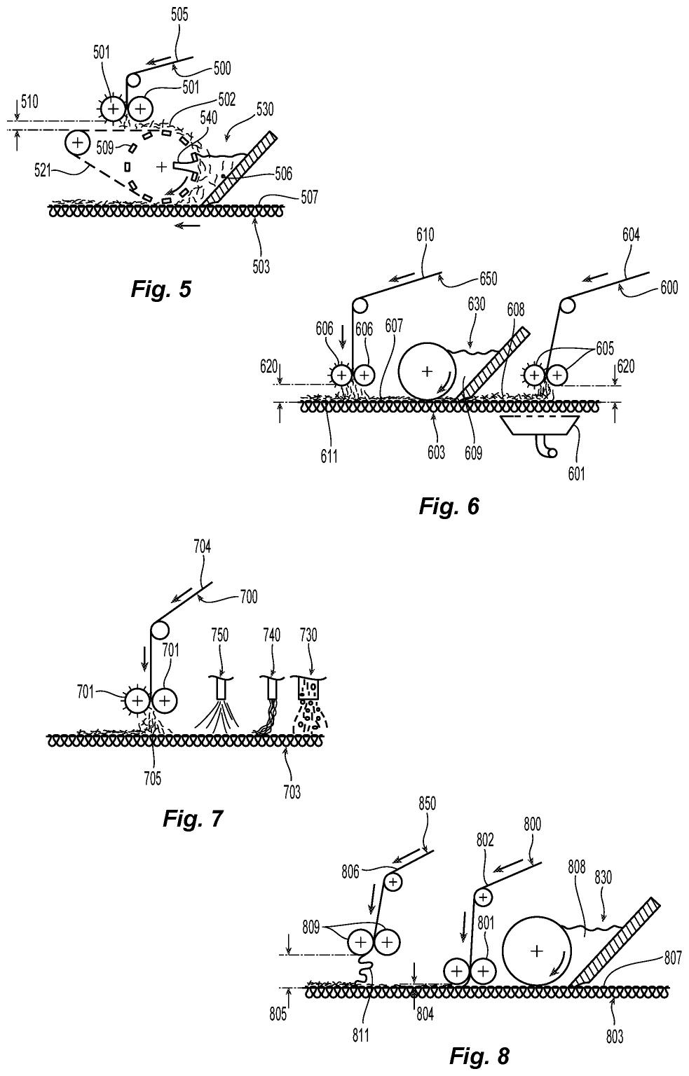

Referring to FIG. 5, a warp 500 containing a plurality of stabilizing fibers initially arranged as a plurality of parallel yarns or filaments 505 is fed through and guided between two cutter rolls 501 positioned a short vertical distance 510, e.g., a minimum distance, above a perforated belt 521 of an applicator 530. The cutter rolls chop each yarn or filament into a plurality of segments staple fibers 502 that are deposited on the belt. The perforated belt delivers the stabilizing fibers, maintained in the warp pattern, to the adhesive puddle 506 where one or more air jets 540 positioned within the perforated roll carrying the perforated belt inject air through the perforations to propel the stabilizing fibers into the adhesive puddle. The adhesive applicator applies the adhesive containing the stabilizing fibers onto the back surface 507 of a tufted fabric 503. The rate at which the stabilizing fibers are deposited onto the perforated belt, the speed of perforated belt, the rate at which the adhesive is fed through the adhesive puddle, the rate at which the adhesive is applied to the back surface and the short vertical distance are controlled to maintain the initial warp alignment, i.e., the pre-determined pattern, in the stabilizing fibers applied to the back surface.

Referring to FIG. 6, a first warp 600 containing a first plurality of stabilizing fibers initially arranged as a plurality of parallel yarns or filaments 604 is fed through and guided between a first pair of cutter rolls 605 positioned a short vertical distance 620, e.g., a minimum distance, above a back surface of a fibrous fabric layer, e.g., a tufted fabric 603. The cutter rolls chop each yarn or filament into a plurality of segments or staple fibers 608 that are deposited on the back surface. In one embodiment, a vacuum box 601 is positioned below the tufted fabric and extends a desired length along the belt to hold the deposited stabilizing fibers on the back surface. The adhesive applicator 630 is then used to deposit adhesive 609 on the back surface following deposition of the first plurality of stabilizing fibers.

In one embodiment, as an alternative to the chopping and deposition of the first plurality of staple fibers before the application of adhesive, or following the chopping and deposition of the first plurality of staple fibers before the application of adhesive, a second warp 650 containing a second plurality of stabilizing fibers initially arranged as a plurality of parallel yarns or filaments 610 is fed through and guided between a second pair of cutter rolls 606 positioned the short vertical distance 620, e.g., a minimum distance, above a back surface 607 of the tufted fabric 603. The cutter rolls chop each yarn or filament into a plurality of segments or staple fibers 611 that are deposited on the back surface after the application of adhesive while maintaining the second warp pattern and pattern uniformity. The presence of the adhesive on the surface serves to keep the fibers in place until heat is applied with or without surface contact pressure to dry or set the adhesive.

Referring to FIG. 7, exemplary embodiments of the application of stabilizing fibers with a plurality of different techniques for adhesive application 700 are illustrated. Three separate adhesive application techniques are illustrated for adhesive application to the back surface 707 of a tufted fabric 703 preceding the deposition of stabilizing fibers 705 originating from a warp 700 containing a plurality of parallel yarns or filaments 704 that is passed through a pair of cutter rolls 701. The adhesive application techniques include, but are not limited to spraying 730, hot melt extrusion 740, and sifting of low melt powders, particles or fibrids 750. In addition to spraying, adhesive application techniques similar to spraying can be used, for example, scatter coating of adhesives. For any given adhesive application technique, the stabilizing fibers arranged as yarns, filaments, segments of yarns or filaments or staple fibers can be directly introduced into these adhesive applications techniques, with or without chopping. As an example, the stabilizing fibers are introduced onto the back surface of a tufted fabric using the adhesive application technique, i.e., in combination with the application of adhesive, while maintaining the pre-determined pattern, e.g., the warp.

In one embodiment, adhesive is applied using the wet-application of suspended low-melt particles or powder suspended in liquids. Wet application of adhesive prior to the dispersal or release of the pre-determined pattern of stabilizing fibers in continuous or chopped form, with or without overfeed, enhances attachment of the deposited stabilizing fibers to the back surface prior to curing the adhesive. A wide variety of heating methods, including but not limited to heated contact rolls or plates, and non-contact methods including hot air, radiation and microwave radiation are used. Adhesive can be applied before, during, or after the deposition of the stabilizing fibers. In one embodiment, low-melting filaments or yarns can be introduced into the pattern of stabilizing fibers or provided in a separate pattern, e.g., a separate warp. In one embodiment, a low-melting solid layer, e.g., a fabric or a film, is introduced onto the back surface either before or after application of the stabilizing fibers. In one embodiment, a low-melt layer is placed under the primary backing of a tufted fabric, i.e., toward the back laps of the tufted fabric, and is activated with heat as the deposited stabilizing fibers arranged in the pre-determined pattern are pressed into the back laps.

Referring to FIG. 8, a first warp 800 containing a first plurality of stabilizing fibers initially arranged as a plurality of parallel yarns or filaments 802 is fed through and guided between a first pair of rolls 801 positioned a short vertical distance 804, e.g., a minimum distance, above a back surface 807 of a fibrous fabric layer, e.g., a tufted fabric 803. The warp is deposited onto the back surface 803 keeping the filaments or yarns straight and rectilinear. The first warp is deposited onto the back surface at a speed approximately equaling the speed of propagation of the tufted fabric. Adhesive 808 is applied to the back surface from an adhesive applicator 830 either before or after the application of the first warp. A second warp 850 containing a second plurality of stabilizing fibers initially arranged as a plurality of parallel yarns or filaments 806 is feed through and guided between a second pair of rolls 801 positioned a vertical distance 805 above the back surface 807 of the tufted fabric 803. The second warp 850 passes through the second pair of rollers at a speed greater than the speed of propagation of the tufted fabric. This results in an overfeed from a larger vertical distance 805 above the back surface of the tufted fabric. The overfeed upon deposition on the back surface forms a planarly-undulating pattern adding XD stability.

Referring to FIG. 10, the result is two overlapping patterns of uncut warps deposited onto the back surface, a first pattern of warps containing the plurality of parallel rectilinear yarns or filaments 1060 and a second pattern of warps containing the plurality of undulating yarns or filaments 1070. These two overlapping patterns provide multidirectional stabilization to the back surface and tufted fabric. The overlapping patterns include filaments or yarns 1060 laying along MD rectilinear lines, and yarns or filaments 1070 in an undulating overlaid and overlapping pattern, crossing over two or more adjacent rectilinear yarns or filaments 1060.

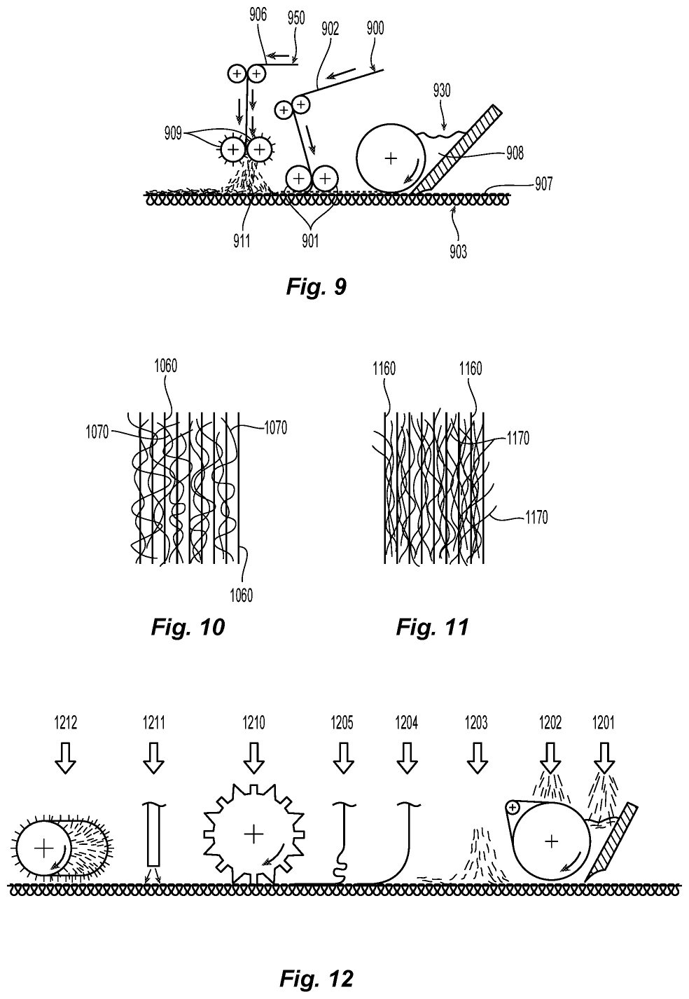

Referring now to FIG. 9, adhesive 908 is applied to the back surface 907 of a tufted fabric 903 from an adhesive applicator 930. A first warp 900 containing a first plurality of stabilizing fibers initially arranged as a plurality of parallel yarns or filaments 902 is feed through and guided between a first pair of rolls 901 positioned a short vertical distance above the back surface 807. The first warp is deposited onto the back surface 803 keeping the filaments or yarns straight and rectilinear. The first warp is deposited onto the back surface at a speed approximately equaling the speed of propagation of the tufted fabric.

A second warp 950 containing a second plurality of stabilizing fibers initially arranged as a plurality of parallel yarns or filaments 906 is fed through and guided between a second pair of cutter rolls 909 positioned a short vertical distance above the back surface 907. The cutter rolls chop each yarn or filament into a plurality of segments or staple fibers 911 that are deposited either with or without overfeed over the first warp pattern and the applied adhesive. When the yarn segments are applied with overfeeding, the extra among of staple fibers provided by overfeeding causes the staple fibers to assume positions at an angle to the machine direction associated with the warp pattern. This provides cross-directional stabilization on the back surface and tufted fabric. Each warp can be deposited either before or after the application of adhesive, i.e., both warps deposited after adhesive, both warps deposited before adhesive, and one warp deposited before adhesive and the other warp deposited after adhesive. The resulting pattern is illustrated in FIG. 11 with the continuous fibers 1160 providing MD stability, and the staple fibers 1170 adding a measure of XD stability.

The patterns illustrated in FIGS. 10 and 11 address the instability of fibrous floorcovering structures, e.g., tufted fabrics or laminates of woven, stitched or knit fabrics and felts, that are subjected to MD processing tension, which builds up residual stress in the machine direction, and increases the chances of eventual shrinkage with temperature variations in the MD direction. The XD direction in such structures remains relaxed and relatively unaffected during initial processing, requiring a lower degree of stabilization.

Referring now to FIG. 12, a plurality of embodiments for deposing stabilizing fibers into a back surface of a surface covering are illustrated. In one embodiment, stabilizing fibers arranged in a pattern deposited into the adhesive puddle 1201 of an adhesive applicator. Alternatively, the stabilizing fibers are deposited onto a roller or belt 1202 that delivers the staple fibers to the adhesive puddle. In one embodiment, the stabilizing fibers are deposited in the pre-determined pattern directly onto the back surface of the fabric 1203 either before or after the application of adhesive. In one embodiment, the stabilizing fibers arranged in the pre-determined pattern are applied directly to the back surface under tension 1204 and at a rate equal to the rate of propagation of the surface covering to maintain the pre-determined pattern. Alternatively, the stabilizing fibers arranged in the pre-determined pattern are applied directly to the back surface as overfed stabilizing fibers 1025 at a rate exceeding the rate of propagation of the surface covering.

In addition to applying the pre-determined pattern of stabilizing fibers to the back surface, the deposited stabilizing fibers can be reoriented from the deposited pattern. Re-orientation can be accomplished by embossing the back surface with patterned rolls 1210, by impacting the back surface containing the stabilizing fibers with intermittent jets of air 1211 and by brushing the back surface containing the stabilizing fibers with rolls or brushes 1212 that pass across the back surface at an angle to the direction of propagation of the surface covering, e.g., on a diagonal. A patterned embossing roll 1210 may have pointed projections that can displace part of the contacted fibers sidewise to achieve reorientation. Reorientation is accomplished with local impingement of air issued intermittently by fixed nozzles 1211 or perforated rollers. In one embodiment, reorientation is accomplished by diagonal brushing 1212 of deposited staple fibers, or overfed warp of stabilizing fibers followed by the placement of a rectilinear warp in the MD. Reorientation can be performed before or after adhesive application. Preferably, reorientation is performed before any applied adhesive is fully set or cooled.

The exemplary embodiments described above can equally be applied to solid-faced floorcoverings such as vinyl tiling or floorcoverings known as LVT or Luxury Vinyl Tiling, as well as combinations of solid-faced or fibrous-faced floorcoverings with highly cushioned backings.

The foregoing written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for stabilizing a surface covering, the method comprising:
arranging a plurality of stabilizing fibers in a pre-determined pattern comprising a uniformity of weight per unit of planar area of stabilizing fibers; and
depositing and adhesively attaching the plurality of stabilizing fibers onto a back surface of the surface covering while maintaining the uniformity of weight per unit of planar area of stabilizing fibers;
wherein:
the predetermined pattern comprises a rectilinear warp of continuous yarns or continuous filaments;
the stabilizing fibers comprise a fiber coefficient of thermal expansion and a fiber coefficient of hygroscopic expansion;
the surface covering comprises a covering coefficient of thermal expansion and a covering coefficient of hygroscopic expansion; and
the fiber coefficient of thermal expansion is smaller than the covering coefficient of thermal expansion, and the fiber coefficient of hygroscopic expansion is less than the covering coefficient of hygroscopic expansion.

2. The method of claim 1, wherein the fiber coefficient of thermal expansion is smaller than one half of the covering coefficient of thermal expansion.

3. The method of claim of 1, wherein:
the method further comprises cutting the continuous yarns or continuous filaments into a plurality of staple fibers; and
depositing the stabilizing fibers comprises depositing the staple fibers onto the back surface of the surface covering while maintaining the uniformity of weight per unit of planar area of stabilizing fibers.

4. The method of claim 3, wherein:
the method further comprises depositing the staple fibers into an adhesive puddle comprising adhesive; and
depositing and adhesively attaching the stabilizing fibers comprises applying the adhesive containing the staple fibers from the adhesive puddle to the back surface of the surface covering.

5. The method of claim 3, wherein:
the method further comprises depositing the stabilizing fibers on a roller in communication with an adhesive puddle comprising adhesive; and
depositing and adhesively attaching the stabilizing fibers comprises using the roller to transfer the staple fibers into the adhesive and applying the adhesive containing the staple fibers to the back surface of the surface covering.

6. The method of claim 1, wherein:
the rectilinear warp of continuous yarns or continuous filaments further comprises additional low-melting adhesive fibers; and
depositing and adhesively attaching the plurality of stabilizing fibers further comprises applying heat to the back surface after deposition of the stabilizing fibers on the back of the surface covering to activate the additional low-melting adhesive.

7. The method of claim 1, wherein the method further comprises reorienting at least a portion of the stabilizing fibers while depositing and adhesively attaching the stabilizing fibers on the back surface.

8. The method of claim 1, wherein depositing and adhesively attaching the plurality of stabilizing fibers comprises applying adhesive to the back surface using a puddle-coater, a spray-coater, a roll-coater or a hot-melt extruder.

9. The method of claim 8, wherein depositing and adhesively attaching the plurality of stabilizing fibers further comprises depositing the plurality of stabilizing fibers simultaneously with applying the adhesive.

10. The method of claim 1, wherein depositing and adhesively attaching the plurality of stabilizing fibers further comprises applying adhesive to the back surface after depositing the plurality of stabilizing fibers.

11. The method of claim 1, wherein the method further comprises modifying a planar orientation of the stabilizing fibers deposited on the back surface using a stream of air applied to the back surface or diagonal brushing across the back surface.

12. The method of claim 1, wherein the rectilinear warp of continuous yarns or continuous filaments comprises a uniformly spaced parallel pattern of continuous yarns or continuous filaments.

13. The method of claim 1, wherein the method further comprises varying at least one of a material composition of the stabilizing fibers, a denier and a spacing between stabilizing fibers in the predetermined pattern.

14. The method of claim 1, wherein the surface covering comprises a tufted fibrous surface covering and the back surface comprises back-laps of the tufted fibrous surface covering.

15. The method of claim 1, wherein the surface covering comprises a woven fibrous surface covering, a knit fibrous surface covering or a nonwoven fibrous surface covering.

16. The method of claim 1, wherein:
the method further comprises:
placing an additional layer on the back surface; and
applying adhesive to the additional layer; and
depositing the plurality of stabilizing fibers further comprises depositing the plurality of stabilizing fibers over the adhesive on the additional layer.

17. The method of claim 16, wherein the additional layer comprises a thermoplastic adhesive layer, a cushioning layer, a fluid blocking layer, or a protective layer.

18. The method of claim 1, wherein the method further comprises embossing the surface covering containing the pre-determined pattern of adhesively attached stabilizing fibers using an embossing tool comprising a plurality of projections to displace at least of portion of the stabilizing fibers and modify a planar orientation of the displaced stabilizing fibers.

19. A method for stabilizing a surface covering, the method comprising:
arranging a first plurality of stabilizing fibers in a first pre-determined pattern comprising a first warp of continuous yarns or continuous filaments comprising a first uniformity of weight per unit of planar area of stabilizing fibers;
depositing the first plurality of stabilizing fibers onto a back surface of the surface covering while maintaining the first uniformity of weight per unit of planar area of stabilizing fibers;
arranging a second plurality of stabilizing fibers in a second pre-determined pattern comprising a second warp of continuous yarns or continuous filaments comprising a second uniformity of weight per unit of planar area of stabilizing fibers; and
depositing the second plurality of stabilizing fibers onto the back surface of the fibrous-based surface covering over the first plurality of stabilizing fibers while maintaining the second uniformity of weight per unit of planar area of stabilizing fibers.

20. The method of claim 19, wherein the method further comprises applying adhesive to the back surface.

21. The method of claim 19, wherein:
depositing the first plurality of stabilizing fibers comprises releasing the first warp onto the back surface at a first speed matching a speed of propagation of the surface covering to deposit the first warp as a parallel rectilinear array; and
depositing the second plurality of stabilizing fibers comprises overfeeding the second warp onto the back surface at a second speed exceeding the speed of propagation of the surface covering to deposit the second warp as an undulating pattern.

22. The method of claim 19, wherein:
depositing the first plurality of stabilizing fibers comprises overfeeding the first warp onto the back surface at a first speed exceeding a speed of propagation of the surface covering to deposit the first warp as an undulating pattern; and
depositing the second plurality of stabilizing fibers comprises overfeeding the second warp onto the back surface at a second speed exceeding the speed of propagation of the surface covering to deposit the second warp as an undulating pattern.

23. The method of claim 19, wherein the first pre-determined pattern and the second pre-determined pattern comprise distinct patterns.

24. The method of claim 19, wherein the method further comprises cutting at least one of the first warp and the second warp into staple fibers before depositing onto the back surface.
